(19) United States
(12) Patent Application Publication
(10) Pub. No.: US 2016/0142108 A1
(43) Pub. Date: May 19, 2016

(54) NEAR-FIELD COMMUNICATION MODULE OF ELECTRONIC DEVICE

(71) Applicants: HONG FU JIN PRECISION INDUSTRY (WuHan) CO. LTD., Wuhan (CN); HON HAI PRECISION INDUSTRY CO., LTD., New Taipei (TW)

(72) Inventors: JUN-ZHI XU, Wuhan (CN); ZHONG-HUANG WANG, Wuhan (CN)

(21) Appl. No.: 14/543,209

(22) Filed: Nov. 17, 2014

(30) Foreign Application Priority Data
Nov. 13, 2014 (CN) 201410638901.3

(51) Int. Cl. H04B 5/00; H04W 4/00

(52) U.S. Cl. CPC H04B 5/0025; H04W 4/008

(57) ABSTRACT

A near-field communication (NFC) module of an electronic device is operable to move between a retracted position and an extended position. The NFC module is extended out of a slot of the electronic device in the extended position, and retracted into the slot in the retracted position. The slot is defined in a side of the electronic device. An NFC induction zone of the NFC module is exposed out of the electronic device in the extended position. The NFC induction zone is configured to carry out NFC functions of the electronic device.

### FIELD

The present disclosure relates to electronic devices, and more particularly to a near-field communication module of an electronic device.

### BACKGROUND

Electronic devices can have near-field communication (NFC) modules. The NFC modules are generally located behind a surface of the electronic device.

### BRIEF DESCRIPTION OF THE DRAWINGS

FIG. 1 is an isometric view of an electronic device including a near-field communication (NFC) module in a retracted position.

FIG. 2 is similar to FIG. 1, but shows the NFC module in an extended position.

FIG. 3 is an exploded, isometric view of an NFC assembly including the NFC module.

FIG. 4 is an assembled, isometric view of the NFC assembly.

FIG. 5 is an enlarged view of circled portion V of FIG. 4.

FIG. 6 is a top plan view of a sliding member of the NFC assembly.

FIGS. 7-11 are top elevational views of the NFC assembly in use.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

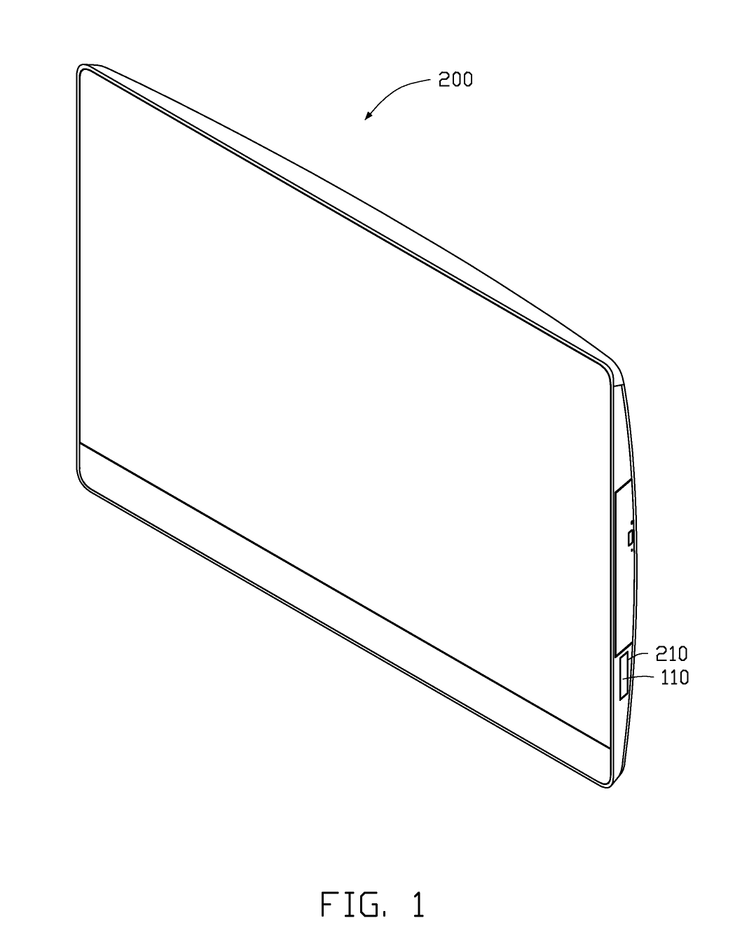

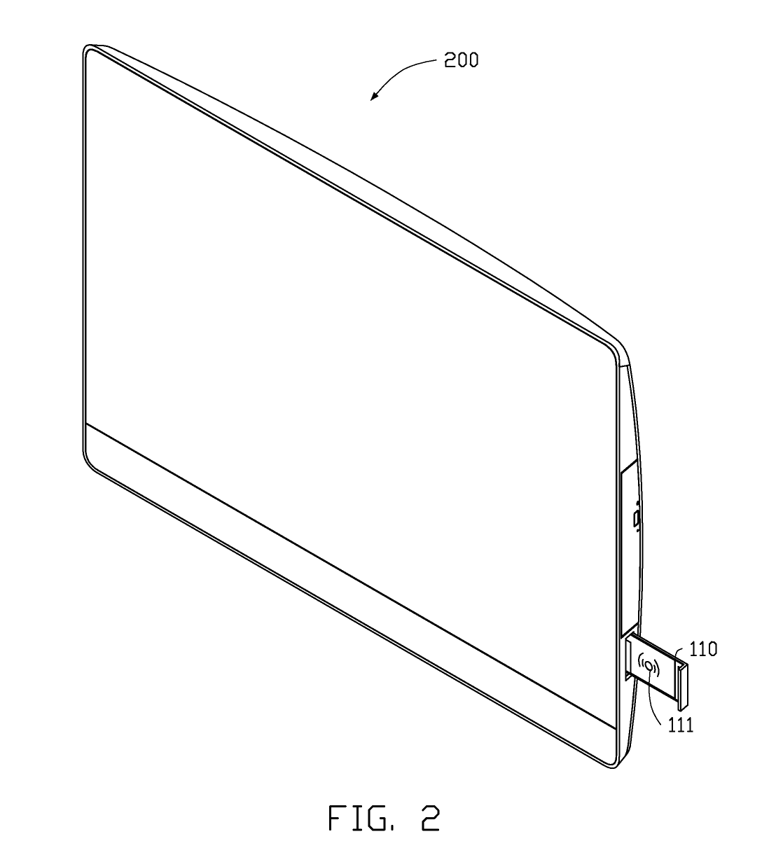

FIG. 1 and FIG. 2 illustrate an exemplary embodiment of an electronic device 200 including a near-field communication (NFC) module 110. The NFC module 110 can be received in a slot 210 defined in the electronic device 200. In at least one embodiment, the slot 210 can be defined in a side surface (not labeled) of the electronic device 200.

The NFC module 110 can be moved between a retracted position (shown in FIG. 1) and an extended position (shown in FIG. 2). In the retracted position, the NFC module 110 is retracted into the slot 210. In the extended position, the NFC module 110 is extended out of the slot 210. The NFC module 110 can include an NFC induction zone (111). The NFC induction zone 111 can carry out NFC functions of the electronic device 200. The NFC induction zone 111 can be exposed out of the electronic device 200 when the NFC module 110 is in the extended position.

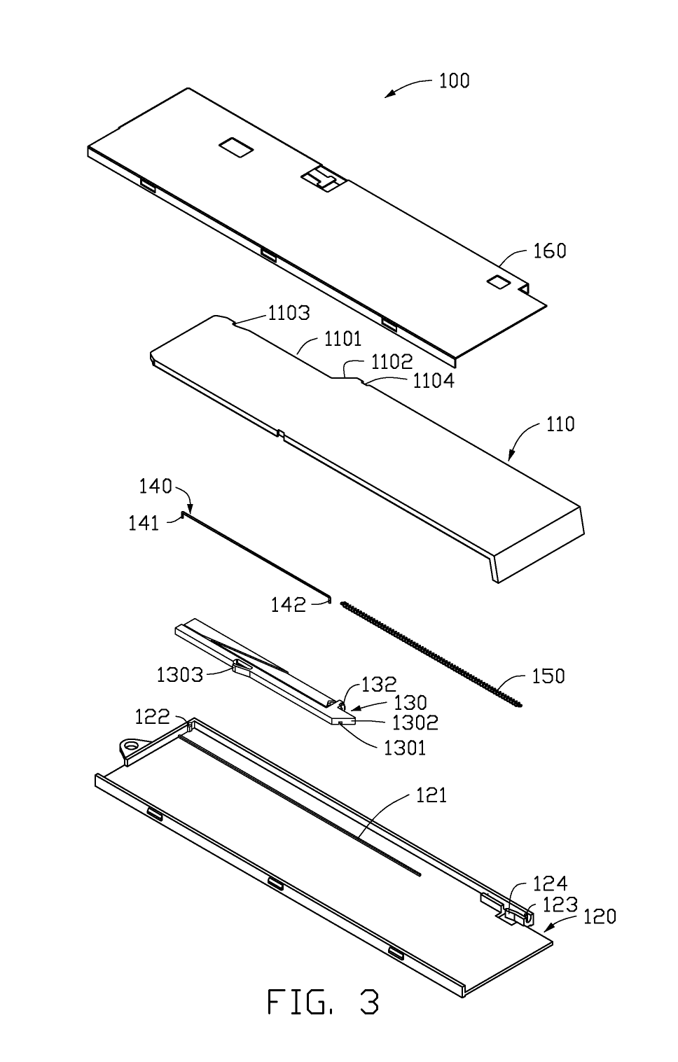

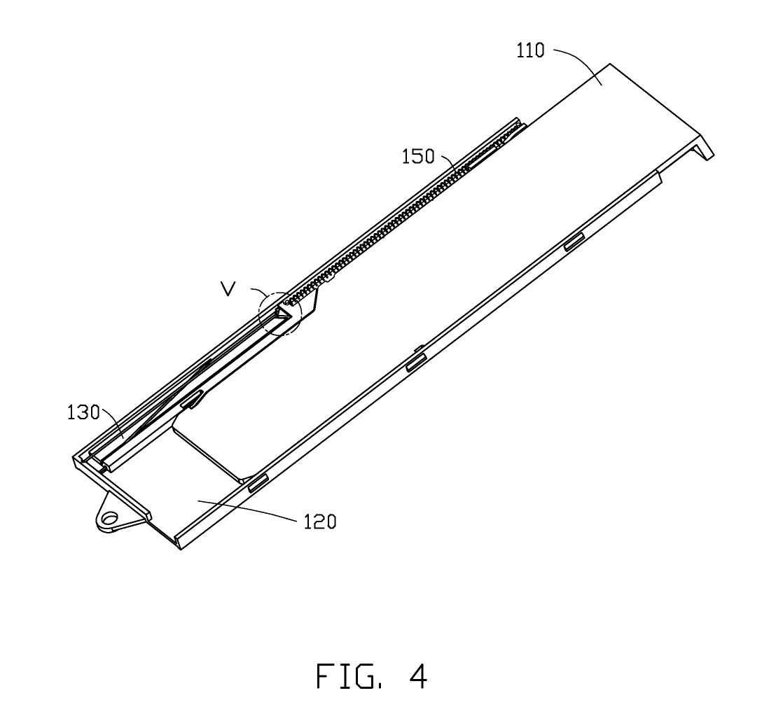

FIGS. 3-4 illustrate an exemplary embodiment of an NFC assembly 100. The NFC assembly 100 can include the NFC module 110, a base tray 120, a sliding member 130, a limiting member 140, an elastic member 150, and a cover 160. A sliding groove 1301 can be defined in a surface of the sliding member 130, and a sliding rail 121 can protrude from a surface of the base tray 120. The sliding rail 121 can be received in the sliding groove 1301 to allow the sliding member 130 to slide along the sliding rail 121.

A cutout 1101 can be defined in the NFC module 110. The sliding member 130 can be received in the cutout 1101. The NFC module 110 can be pulled and pushed to move between the extended position and the retracted position, thereby driving the sliding member 130 to slide along the sliding rail 121.

The NFC module 110 can further include a first pushing portion 1102 and a second pushing portion 1103. The sliding member 130 can further include a third pushing portion 1302 and a fourth pushing portion 1303. When the NFC module 110 is pushed, the first pushing portion 1102 pushes the third pushing portion 1302 to drive the sliding member 130 to slide along the sliding rail 121. When the NFC module 110 is pulled, the second pushing portion 1103 pushes the fourth pushing portion 1303 to drive the sliding member 130 to slide along the sliding rail 121.

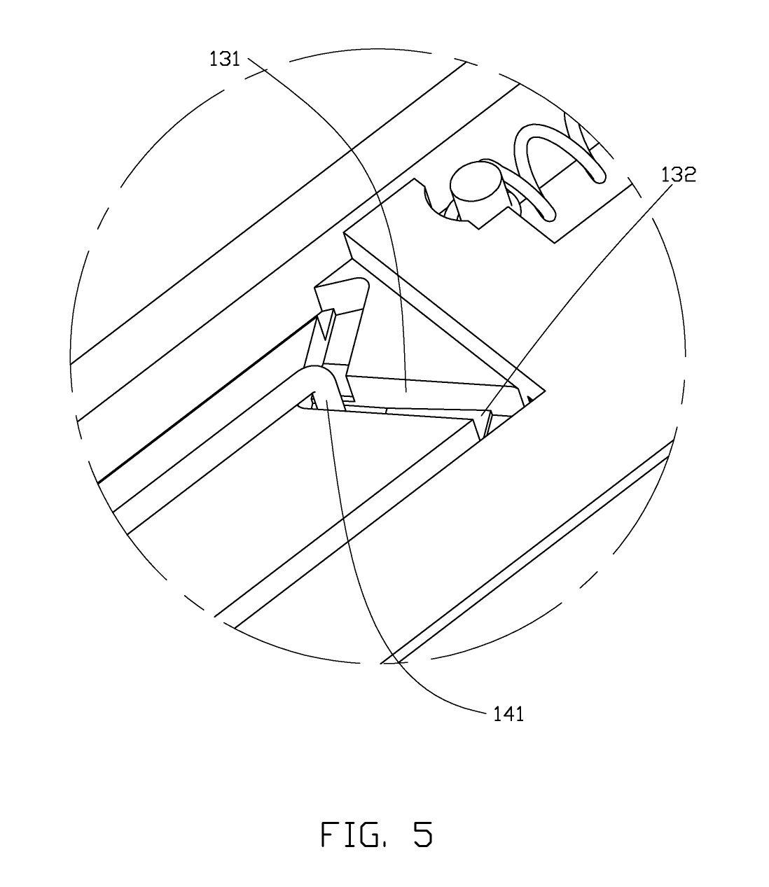

An end portion of the base tray 120 can define a pivoting hole 122. The limiting member 140 can include a pivoting protrusion 141. The pivoting protrusion 141 can be inserted into the pivoting hole 122 to allow the limiting member 140 to pivot about the pivoting protrusion 141. The limiting member 140 can also include a limiting protrusion 142. In one embodiment, the pivoting protrusion 141 is located at one end portion of the limiting member 140, and the limiting protrusion 142 is located at another end portion of the limiting member 140. The limiting protrusion 142 can be inserted into a guiding track 131 (shown in FIG. 5) defined in the sliding member 130. As the sliding member 130 slides along the sliding rail 121, the limiting protrusion 142 can slide along the guiding track 131, and the limiting member 140 can pivot about the pivoting protrusion 141 as the limiting protrusion 142 slides along the guiding track 131.

One end portion of the elastic member 150 can be secured to a first securing portion 123 of the base tray 120, and another end portion of the elastic member 150 can be secured to a second securing portion 132 of the sliding member 130. Thus, the elastic member 150 can be compressed as the NFC module 110 is moved to the extended position, and be extended as the NFC module 110 is moved to the retracted position.

The cover 160 can be covered on the base tray 120. The NFC module 110, the sliding member 130, the limiting member 140, and the elastic member 150 can be received in a space cooperatively defined between the base tray 120 and the cover 160.

Referring to FIG. 3 again, the base tray 120 can further include a latching portion 124. The latching portion 124 can be located at an inner sidewall of the base tray 120. A side of the NFC module 110 can define a latching notch 1104. When the NFC module 110 is in the extended position, the latching portion 124 can be engaged in the latching notch 1104 to prevent the NFC module 110 from retracting back into the slot of the electronic device.

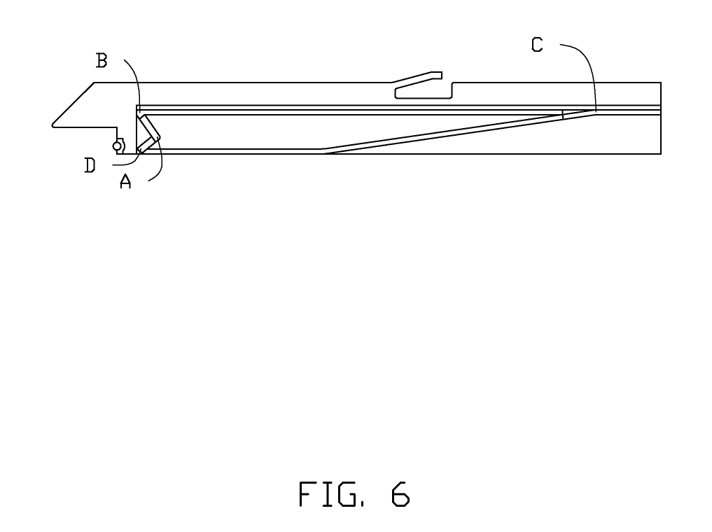

Referring to FIGS. 5-6, the guiding track 131 of the sliding member 130 can include a plurality of vertex points, such as a first vertex point A, a second vertex point B, a third vertex point C, and a fourth vertex point D. The limiting protrusion 142 can be moved along the guiding track 131 from the first vertex point A to the fourth vertex point D in sequence. The sliding member 130 can further include a plurality of steps 132 formed inside the guiding track 131. The plurality of steps 132 bias the limiting protrusion 142 to move along the guiding track 131 in one direction. After the limiting protrusion 142 is moved from the first vertex point A to the fourth vertex point D in sequence, the limiting protrusion 142 can be moved to the first vertex point A from the fourth vertex point D. Thus, the limiting protrusion 142 can be moved along the guiding track 131 in a continuous sequence without reversing direction.

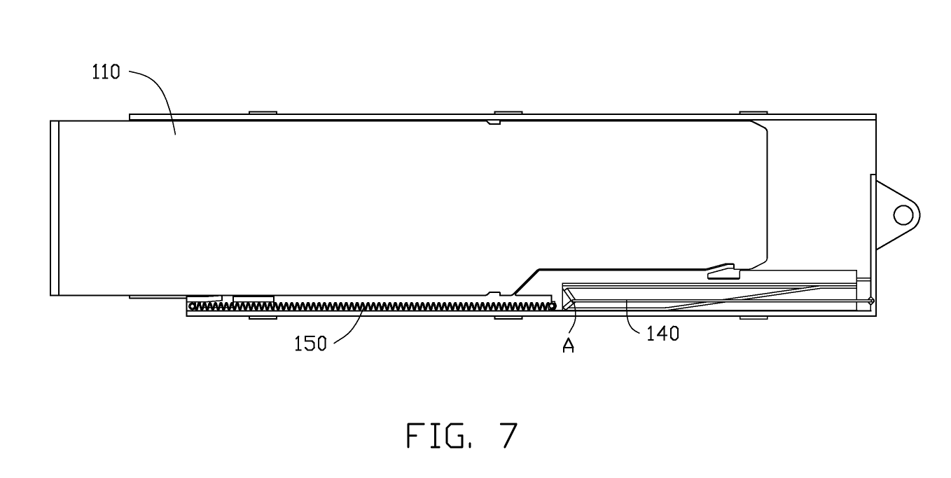

FIGS. 7-11 illustrate how the NFC module 110 is moved between the retracted position and the extended position.

In FIG. 7, the NFC module 110 is in the retracted position, and the limiting protrusion 142 is located at the first vertex point A.

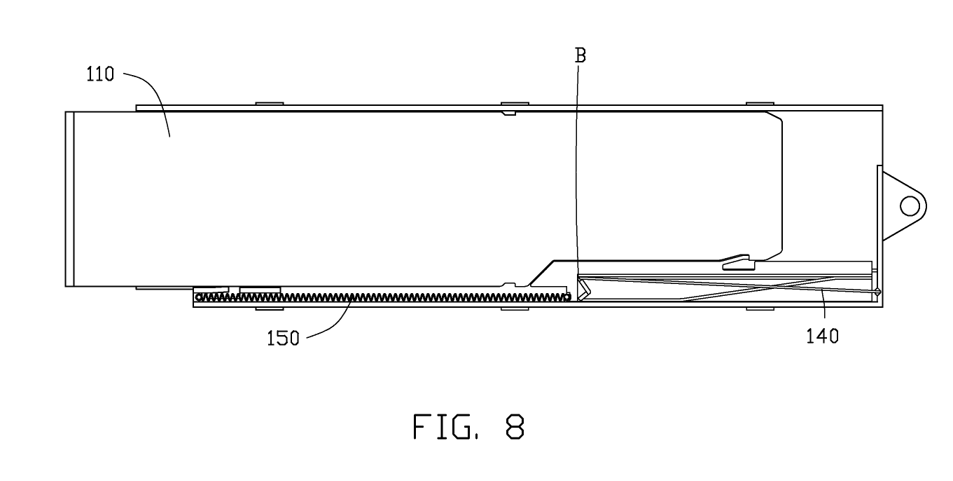

In FIG. 8, the NFC module 110 is pushed into the electronic device 200, thereby slightly stretching the elastic member 150 and moving the sliding member 130 along the sliding rail 121. As the sliding member 130 moves along the sliding rail 121, the limiting protrusion 142 is guided to move to the second vertex point B. When the limiting protrusion 142 is located at the second vertex point B, the corresponding step 132 prevents the limiting protrusion 142 from moving back to the first vertex point A.

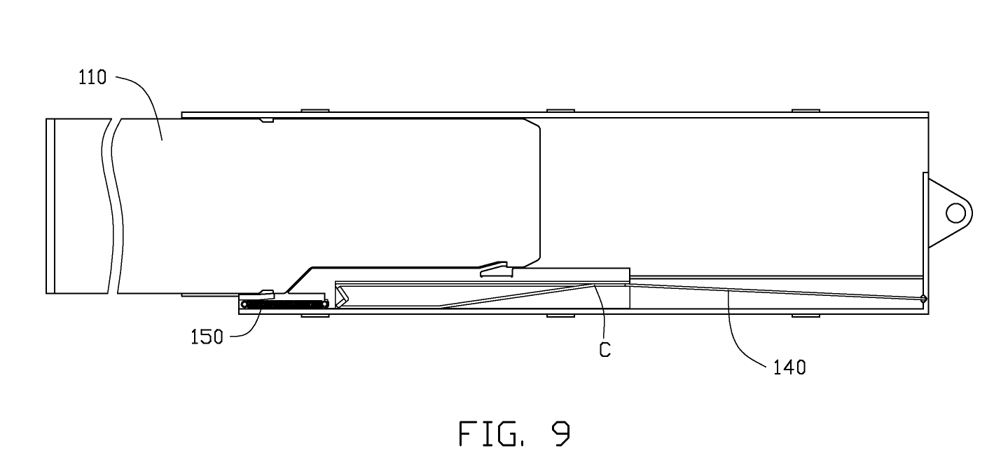

In FIG. 9, the NFC module 110 is released, and the elastic member 150 restores, thereby pulling the sliding member 130. When the sliding member 130 is pulled by the elastic member 130, the limiting protrusion 142 is driven to partially move along the guiding track 131, thereby causing the NFC module 110 to partially pop out from the side slot 210. When the NFC module 110 is popped out of the side slot 210, the NFC module 110 can be pulled out of the side slot 210 to move to the extended position. In the extended position, the limiting protrusion 142 is located at the third vertex point C, and the corresponding step 132 prevents the limiting protrusion 142 from moving back along the guiding track 131 toward the second vertex point B. In the extended position, the elastic member 150 is compressed, and the latching protrusion 124 is engaged in the latching notch 1104.

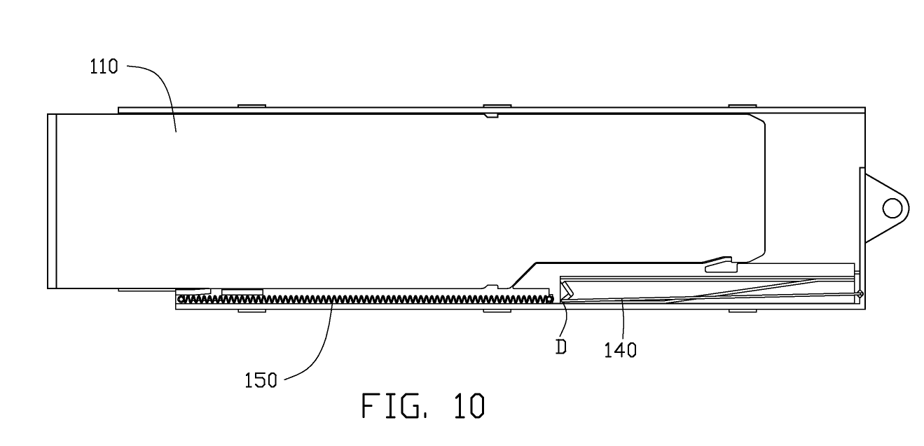

In FIG. 10, the NFC module 110 is pushed into the slot 210 to disengaged the latching protrusion 124 from the latching notch 1104 and guide the limiting protrusion 142 to move to the fourth vertex point D. When the limiting protrusion 142 is located at the fourth vertex point D, the corresponding step 132 prevents the limiting protrusion 142 from moving back along the guiding track toward the third vertex point C, and the elastic member 150 is stretched.

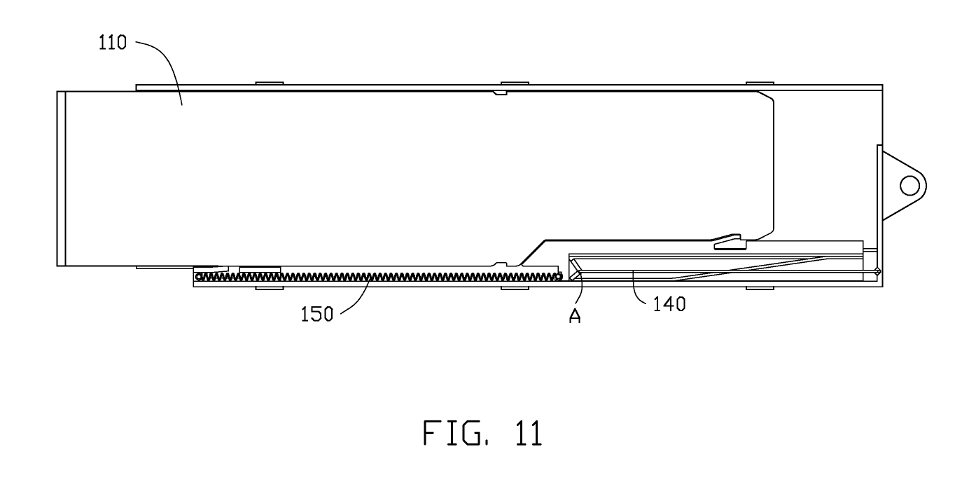

In FIG. 11, the NFC module 110 is released, and the elastic member 150 restores to pull the sliding member 130, thereby guiding the limiting protrusion 142 to move back to the first vertex point A. Thus, the NFC module 110 is returned to the retracted position.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An electronic device comprising;
a slot defined in the electronic device for receiving a near-field communication (NFC) module of the electronic device;
wherein the slot is defined in a side of the electronic device; the NFC module is operable to move between an extended position and a retracted position, the NFC module extended out of the slot in the extended position, and retracted into the slot in the retracted position; the NFC module comprises an NFC induction zone that is exposed when the NFC module is extended out of the slot, the NFC induction zone configured to carry out NFC functions of the electronic device.

2. The electronic device as in claim 1, wherein the electronic device further comprises a base tray received in the slot; the NFC module and a sliding member are received in the base tray; the sliding member is coupled to the NFC module, and the NFC module and the sliding member are slidable in the base tray; the sliding member moves together with the NFC module.

3. The electronic device as in claim 2, wherein a surface of the sliding member defines a sliding groove, and a sliding rail protrudes from a surface of the base tray; and the sliding rail is received in the sliding groove to guide the sliding member to slide along the sliding rail as the sliding member moves with the NFC module.

4. The electronic device as in claim 3, wherein a limiting member limits movement of the sliding member; one end portion of the limiting member forms a pivoting portion configured to be inserted into a pivoting hole defined in the base tray, and another end portion of the limiting member forms a limiting protrusion configured to be inserted into a guiding track defined in the sliding member, the limiting member pivotable about the pivoting portion; the guiding track comprises a first vertex point, a second vertex point, a third vertex point, and a fourth vertex point; when the limiting protrusion is located at the first vertex point, the NFC module is in the retracted position, and when the limiting protrusion is located at the third vertex point, the NFC module is in the extended position; as the NFC module moves from the retracted position to the extended position, the limiting protrusion is guided to move from the first vertex point to the second vertex point, and then from the second vertex point to the third vertex point; as the NFC module moves from the extended position to the retracted position, the limiting protrusion is guided to move from the third vertex point to the fourth vertex point, and then from the fourth vertex point to the first vertex point; and the limiting member pivots about the pivoting portion as the limiting portion moves along the guiding track.

5. The electronic device as in claim 4, wherein the NFC module extends and retracts along a line, and the sliding member moves with the NFC module along the line.

6. The electronic device as in claim 5, wherein a plurality of steps is formed inside the guiding track, the steps biasing the limiting protrusion to move along the track in one direction as the sliding member is moved with the NFC module between the retracted position and the extended position.

7. The electronic device as in claim 6, wherein one end portion of an elastic member is secured to a first securing portion of the base tray, and another end portion of the elastic member is secured to a second securing portion of the sliding member, the elastic member extended when the NFC module is in the retracted position, and compressed when the NFC module is in the extended position; to move the NFC module from the refracted position to the extended position, the NFC module is pushed into the electronic device, thereby slightly stretching the elastic member and moving the sliding member along the sliding rail; as the sliding member moves along the sliding rail, the limiting protrusion is guided to move to the second vertex point; when the limiting protrusion is located at the second vertex point, the corresponding step prevents the limiting protrusion from moving back along the guiding track toward the first vertex point; the NFC module is released, and the elastic member restores, thereby pulling the sliding member; when the sliding member is pulled by the elastic member, the limiting protrusion is driven to partially move along the guiding track, thereby causing the NFC module to partially pop out from the slot; when the NFC module is popped out of the slot, the NFC module can be pulled out of the slot to move to the extended position; to move the NFC module from the extended position to the retracted position, the NFC module is pushed into the slot to guide the limiting protrusion to move to the fourth vertex point; when the limiting protrusion is located at the fourth vertex point, the corresponding step prevents the limiting protrusion from moving back along the guiding track toward the third vertex point, and the elastic member is stretched; and the NFC module is released, and the elastic member restores to pull the sliding member, thereby guiding the limiting protrusion to move back to the first vertex point.

8. The electronic device as in claim 7, wherein the NFC module comprises a first pushing portion and a second pushing portion, and the sliding member comprises a third pushing portion and a fourth pushing portion; the first pushing portion of the NFC module pushes the sliding member by the third pushing portion when the NFC module is pushed into the slot, and the second pushing portion of the NFC module pushes the sliding member by the fourth pushing portion when the NFC module is pulled out of the slot; the base tray further comprises a latching portion located at an inner sidewall of the base tray, and a side of the NFC module defines a latching notch; when the NFC module is in the extended position, the latching portion is engaged in the latching notch to prevent the NFC module from retracting back into the slot of the electronic device; and the latching portion is disengaged from the latching slot by pushing the NFC to retract into the slot.

9. The electronic device as in claim 8, wherein the NFC module is made of plastic.

10. The electronic device as in claim 8, wherein the electronic device is an all-in-one electronic device.

11. A near field communication (NFC) assembly of an electronic device comprising:
a base tray received inside the electronic device;
an NFC module received in the base tray and operable to be moved between an extended position and a retracted position, the NFC module extended out of a slot of the electronic device in the extended position, and retracted into the slot in the retracted position;
a sliding member slidably received in the base tray and coupled to the NFC module;
a limiting member received in the base tray and configured to limit movement of the sliding member in the base frame; and
an elastic member received in the base tray and configured to pull the sliding member when restored from being stretched;
wherein the base tray comprises a sliding rail, a sliding groove is defined in the sliding member, and the sliding rail is received in the sliding groove to guide the sliding member to slide along the sliding rail; and the NFC module comprises an NFC induction zone that is exposed out of the electronic device when the NFC module is in the extended position, the NFC induction zone configured to carry out NFC functions of the electronic device.

12. The NFC assembly as in claim 11, wherein a pivoting portion of the limiting member is inserted into a pivoting hole of the base frame, and a limiting portion of the limiting member is inserted into a guiding track defined in the sliding member to limit movement of the sliding member, the limiting member pivotable about the pivoting portion as the limiting member moves along the guiding track.

13. The NFC assembly as in claim 12, wherein the NFC module extends out of the slot and retracts into the slot along a line, the sliding member moving together with the NFC module along the line.

14. The NFC assembly as in claim 13, wherein the guiding track comprises a first vertex point, a second vertex point, a third vertex point, and a fourth vertex point; when the limiting protrusion is located at the first vertex point, the NFC module is in the retracted position, and when the limiting protrusion is located at the third vertex point, the NFC module is in the extended position; as the NFC module moves from the retracted position to the extended position, the limiting protrusion is guided to move from the first vertex point to the second vertex point, and then from the second vertex point to the third vertex point; and as the NFC module moves from the extended position to the retracted position, the limiting protrusion is guided to move from the third vertex point to the fourth vertex point, and then from the fourth vertex point to the first vertex point.

15. The NFC assembly as in claim 14, wherein a plurality of steps is formed inside the guiding track, the steps biasing the limiting protrusion to move along the track in one direction as the sliding member is moved with the NFC module between the retracted position and the extended position.

16. The NFC assembly as in claim 15, wherein one end portion of the elastic member is secured to a first securing portion of the base tray, and another end portion of the elastic member is secured to a second securing portion of the sliding member, the elastic member extended when the NFC module is in the retracted position, and compressed when the NFC module is in the extended position; to move the NFC module from the refracted position to the extended position, the NFC module is pushed into the electronic device, thereby slightly stretching the elastic member and moving the sliding member along the sliding rail; as the sliding member moves along the sliding rail, the limiting protrusion is guided to move to the second vertex point; when the limiting protrusion is located at the second vertex point, the corresponding step prevents the limiting protrusion from moving back along the guiding track toward the first vertex point; the NFC module is released, and the elastic member restores, thereby pulling the sliding member; when the sliding member is pulled by the elastic member, the limiting protrusion is driven to partially move along the guiding track, thereby causing the NFC module to partially pop out from the side slot; when the NFC module is popped out of the side slot, the NFC module can be pulled out of the side slot to move to the extended position; to move the NFC module from the extended position to the retracted position, the NFC module is pushed into the slot to guide the limiting protrusion to move to the fourth vertex point; when the limiting protrusion is located at the fourth vertex point, the corresponding step prevents the limiting protrusion from moving back along the guiding track toward the third vertex point, and the elastic member is stretched; and the NFC module is released, and the elastic member restores to pull the sliding member, thereby guiding the limiting protrusion to move back to the first vertex point.

17. The NFC assembly as in claim 16, wherein the NFC module comprises a first pushing portion and a second pushing portion, and the sliding member comprises a third pushing portion and a fourth pushing portion; the first pushing portion of the NFC module pushes the sliding member by the third pushing portion when the NFC module is pushed into the slot, and the second pushing portion of the NFC module pushes the sliding member by the fourth pushing portion when the NFC module is pulled out of the slot; the base tray further comprises a latching portion located at an inner sidewall of the base tray, and a side of the NFC module defines a latching notch; when the NFC module is in the extended position, the latching portion is engaged in the latching notch to prevent the NFC module from retracting back into the slot of the electronic device; and the latching portion is disengaged from the latching slot by pushing the NFC to retract into the slot.

18. The NFC assembly as in claim 17, wherein the NFC module is made of plastic.

19. The NFC assembly as in claim 17, wherein the electronic device is an all-in-one electronic device.

20. The NFC assembly as in claim 17 further comprising a cover configured to cooperatively define a receiving space with the base tray; and the NFC module, the sliding member, the elastic member, and the limiting member are all received inside the receiving space.
